(19) United States
(12) Patent Application Publication
(10) Pub. No.: US 2022/0189444 A1
(43) Pub. Date: Jun. 16, 2022

(54) Note stabilization and transition boost in automatic pitch correction system

(71) Applicant: Slate Digital France, Grenoble (FR)

(72) Inventors: Fabrice Gabriel Paumier, Los Angeles, CA (US); Theo Rover, Los Angeles, CA (US); Raphael Cathelain, Los Angeles, CA (US)

(21) Appl. No.: 17/121,493

(22) Filed: Dec. 14, 2020

(51) Int. Cl. G10H 1/36; G10H 1/46; G10H 1/12; G10H 1/00

(52) U.S. Cl. CPC G10H 1/366; G10H 1/46; G10H 2210/331; G10H 1/0025; G10H 2210/066; G10H 1/125

(57) ABSTRACT

Disclosed is subject matter related generally to audio signal processing, and in particular to automatic pitch correction systems.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter related generally to audio signal processing, and in particular to automatic pitch correction systems.

### Background of the Invention

A musical sound and a corresponding audio signal are defined by many different qualities. One quality is the signal amplitude, often defined in decibels (dB), and this quality relates to the volume at which the corresponding sound is heard. Another quality is the sounds timber, which can be used to mark the difference between one instrument and another. A third quality is pitch, which can be defined by the fundamental frequency of an audio signal. Pitch can be further defined in relation to a musical scale so that it is possible to identify whether the sound is in tune or out of tune with the given scale.

In the case of vocals alongside music instrument, the amplitude, timber and pitch of a voice should jive with other instruments to create pleasant musical sounds. Often however, a singer's vocals have a pitch that is out of tune with the scale of the other instruments. When this happens, the musical sounds are usually unpleasant for a listener.

Experienced singers can adjust their pitch on the fly so that they are in tune with a particular ensemble of instruments. For inexperienced singers, there are automatic pitch correction devices that improve or correct the pitch to a target scale. These devices make it appear to a listener that the inexperienced singer is in tune with the scale of the other instruments. One of these kinds of devices are disclosed in U.S. Pat. No. 5,973,252 (the '252 patent).

These devices are not only capable of automatically correcting the pitch of a singers voice. In some cases the devices have been employed creatively to extremely modify the pitch of a voice. Such extreme modifications can sound robotic or shrill and are frequently used in certain genres of music, like hip-hop and rap.

The device of the '252 patent and those like it typically detect the pitch of a singer's vocal and then compares it to a reference scale. When necessary, a correction is applied to the the audio signal so that the pitch better aligns with the reference scale. The result is a more tuned in vocal.

### SUMMARY OF THE INVENTION

The subject matter consists in a pitch stabilizer and transition boost in the context of the automatic pitch correction system. Automatic pitch correction systems consist in taking an input signal and returning an output signal whose pitch was corrected. It can be typically split into three parts: detection, decision and correction. The following inventions affect the decision part of the automatic pitch correction system, which determines by how much one has to correct the pitch based on the input pitch estimation. Based on specific notes defined by the musical scale, the continuous input pitch signal is transformed into a discrete target pitch signal. Because the signal is now discrete, hard transitions happen over time when the output pitch switches from one note to another.

Pitch stabilizer—Because the target pitch signal is discrete, target notes can sometimes be extremely short and result in the retuned voice to flip to the note above or below for a very short period. This creates audio artifacts that are typical of standard pitch correction algorithms and can be desired in some situations. However, it can also be beneficial to sometimes discard these small notes in order to obtain a more natural and artifact-free result. The pitch stabilizer automatically smooths out these small target notes based on their length, the previous notes and previous notes lengths. A timing setting allows to control the sensitivity of the pitch stabilizer.

In one example, what may be claimed is:

1. A method to remove pitch variations due to pitch occurrences shorter than a certain duration in a retuned audio signal.
2. The method of claim 1 further comprising the steps of:
detecting the pitch of an audio signal
discretizing the values of the detected pitch
stabilizing short variations of the detected pitch signal.
   3. The method of claim 2 further comprising the step of using a sequence of target pitches to discretize the values of the detected pitch.
   4. The method of claim 3 wherein a sequence of target pitches {xj} is computed based on a musical scale set by the user.
   5. The method of claim 3 wherein a sequence of target pitches {xj} is computed based on a sequence of musical keys set by a user.
   6. The method of claim 3 further comprising the step of determining the discrete value pd of a pitch signal p depending on the sequence of target pitches {xj} as the value of {xj} at index argminj (log(p)−log(xj))
   7. The method of claim 2 further comprising the step of detecting a value change in the discretized pitch signal.
   8. The method of claim 7 further comprising the step of measuring the duration since the previous value change of the discrete pitch signal
   9. The method of claim 8 further comprising the step of storing information on previous pitch values and their durations
   10. The method of claim 9 further comprising the step of using a time threshold set by the user to control the sensitivity of stabilization
   11. The method of claim 10 further comprising the step of computing a pitch correction factor threshold based on a sequence of target pitches {xj}
   12. The method of claim 11 further comprising the step of analyzing said information to decide whether the current pitch p2 has to be replaced by a stabilized pitch p1.
   13. The method of claim 12 further comprising the step of replacing pitch p2 by pitch pitch p1, if pitch p1 is followed by pitch p2 and pitch p1 and pitch p2 duration is inferior to the time threshold.
   14. The method of claim 12 further comprising the step of replacing pitch p2 by pitch p1, when pitch p1 is followed by pitch p0 (indicating no pitch detection), pitch p2 and pitch p1, and the combined duration of pitch p2 and pitch p0 is inferior to the time threshold.
   15. The method of claim 12 further comprising the step of replacing pitch p2 by pitch p1, when pitch p1 is followed by pitch p2, pitch p0 (indicating a no-detection) and pitch p1, and the combined duration of pitch p0 and pitch p2 is inferior to the time threshold.
   16. The method of claim 12 further comprising the step of replacing 2 pitches p2 by pitch p1, when pitch p1 is followed by a first pitch p2, pitch p0 (indicating a no-detection), a second pitch p2 and pitch p1, and the combined duration of first pitch p2, pitch p0 and second pitch p0 is inferior to the time threshold.
   17. The method of claim 12 further comprising the step of ignoring the pitch stabilization process if the ratio current pitch p1/stabilized pitch p2 or current pitch p2/stabilized pitch p1 is above the pitch correction factor threshold.
   18. The method of claim 17 further comprising the step of using a two-stage stabilization process.
   19. The method of claim 18 wherein the second stabilization stage uses a time threshold that is superior to the first stabilization stage.
   20. The method of claim 17 further comprising the step of replacing the second pitch p2 by p1, when a first pitch p2 is followed by a first pitch p1, a second pitch p2 and a second pitch p1, when the duration of the first pitch p1 is superior to the first stabilization stage time threshold and the duration of the second pitch p2 is inferior to the first stabilization stage time threshold.
   21. The method of claim 17 further comprising the step of replacing the first pitch p2, pitch p3 and second pitch p2 by pitch p1 when pitch p1 is followed by first pitch p2, pitch p3, second pitch p2 and pitch p1, when the duration of pitch p3 is inferior to the first stabilization stage time threshold and the combined duration of first pitch p2, pitch p3 and second pitch p2 is inferior to the second stabilization stage time threshold.

Transition boost—Hard transitions sound unnatural to human hearing, and a standard use of automatic pitch correction systems consist in smoothing these transitions to make them sound more natural. But the hard retune effect has also been used creatively in modern music productions, and the audio artifacts generated by the hard transitions are now very common. This invention aims at amplifying the hard retune effect instead of reducing it. This amplification can be used creatively to increase the unnatural sound of the pitch correction. While low-pass filters are usually used to reduce transitions in a control signal, here a shelf filter is used to increase the high frequency content of the pitch correction signal in order to boost the transition.

In one embodiment, what may be claimed is:

22. A method for enhancing or increasing the transition between two notes in a retuned audio signal.
23. The method of claim 22, comprising the steps of
detecting the pitch of an audio signal
discretizing the values of the detected pitch
enhancing pitch correction on note changes
   24. The method of claim 23 further comprising the step of using a sequence of target pitches to discretize the values of the detected pitch.
   25. The method of claim 24 wherein a sequence of target pitches {xj} is computed based on a musical scale set by the user.
   26. The method of claim 24 wherein a sequence of target pitches {xj} is computed based on a sequence of musical keys set by a user.
   27. The method of claim 24 further comprising the step of determining the discrete value pd of a pitch signal p depending on the sequence of target pitches {xj} as the value of {xj} at index argminj (log(p)−log(xj))
   28. The method of claim 23 further comprising the step of detecting a value change in the discretized pitch signal.
   29. The method of claim 28 wherein information of a change in the pitch target signal is used to enhance the retuning of the audio signal when the change occurs.
   30. The method of claim 29 further comprising the step of computing the pitch correction signal as the discretized pitch signal divided by the detected pitch signal.
   31. The method of claim 30, further comprising the step of increasing the discontinuities in the pitch correction signal when the change occurs;
   32. The method of claim 31, further comprising the step of using a high-shelf filter to increase the discontinuity of the pitch correction signal;
   33. The method of claim 32, further comprising the step of triggering the activation of the high-shelf filter to the pitch correction signal when there is a note change;
   34. The method of claim 33, further comprising the step of activating the high-shelf filter for a limited time following the transition from the first note to the second note.
   35. The method of claim 34, wherein the time during which the high-shelf filter is active can be set by the user.

The stabilizer makes stabilization decisions as follows. First the stabilizer is turned on. The stabilizer's algorithm asks, how long was the beginning of the last silence? is this time duration shorter or longer than the stabilizer timing setting? If the last silence duration is longer than stabilization timing, then the algorithm ignores the next stabilization order where silence needs to be considered. Thereafter, the algorithm asks if the target has changed. If the target has not changed, the algorithm activates a increment counter trust. The increment counter trust essentially measures the duration of targeted notes. If the target has changed, then the algorithm makes a plurality of comparisons. If the new target is the same as the previous target, the new target is not equal to zero, and the counter trust is less than stabilizer timing, if so then the algorithm poses another question. Otherwise the algorithm skips to a comparison between current and zero. Pursuant to the former, the algorithm makes a comparison by asking if there is a silence between the previous and current target. If there is a silence the target period to stabilize is taken after the start of the current target. If there is not a silence the target period to stabilize is taken just before the silence start. If the stabilization period is taken before silence start, the stabilization will be ignored if the silence is too old or long. Then the algorithm asks if stabilization has been blocked at any point. If stabilization has not been blocked, the algorithm asks if pitch correction factor would be not too large or not too small. If the answer is yes, the target period is stabilized. If stabilization has been blocked, then the ignore stabilization state is reset. Then the algorithm asks if the current target is zero. If it is not, then ignore stabilization state is reset. Then the algorithm assesses if the new target is zero. If it is zero, the silence position is updated, and the stabilizer cycle ends. Otherwise the counter trust is reset, and previous target, current target, and current target position are updated, and the algorithm may repeat the cycle.

### BRIEF DESCRIPTION OF THE SEVERAL VIEWS OF THE DRAWINGS

The manner in which these objectives and other desirable characteristics can be obtained is explained in the following description and attached figures in which:

FIG. 1 is a compute target flowchart;

FIG. 2a is chart of a target pitch;

FIG. 2b is a chart of a stabilized target pitch;

FIG. 3a is a first part of a stabilizer algorithm flowchart;

FIG. 3b is a second part of a stabilizer algorithm flowchart;

FIG. 4a is a target note v. time chart before simple stabilization;

FIG. 4b is a table;

FIG. 4c is a target note v. time chart after simple stabilization;

FIG. 5a is a target note v. time chart before stabilization;

FIG. 5b is a table;

FIG. 5c is a target note v. time chart after stabilization;

FIG. 6a is a target note v. time chart before stabilization;

FIG. 6b is a table;

FIG. 6c is a target note v. time chart after stabilization;

FIG. 7a is a target note v. time chart before stabilization;

FIG. 7b is a table;

FIG. 7c is a target note v. time chart after stabilization;

FIG. 8a is a target note v. time chart before stabilization;

FIG. 8b is a target note v. time chart after stabilization;

FIG. 9a is a target note v. time chart before stabilization;

FIG. 9b is a reject target note v. time chart after stabilization;

FIG. 9c is a target not v. time chart after stabilization;

FIG. 10a is a target note v. time chart before stabilization;

FIG. 10b is a rejected target note v. time chart after stabilization;

FIG. 10c is a target note v. time chart after stabilization;

FIG. 11a is a pitch v. time chart;

FIG. 11b is a pitch-shifting factor v. time chart;

FIG. 11c is a pitch v. time chart;

FIG. 12 is a group of charts that illustrate how negative speed is obtained.

FIG. 13 is an outline pitch-shifting factor plot;

FIG. 14a is an amplitude v. time chart;

FIG. 14b is an amplitude v. time chart;

FIG. 15 is an outline pitch-shifting factor plot.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFFERED EMBODIMENTS

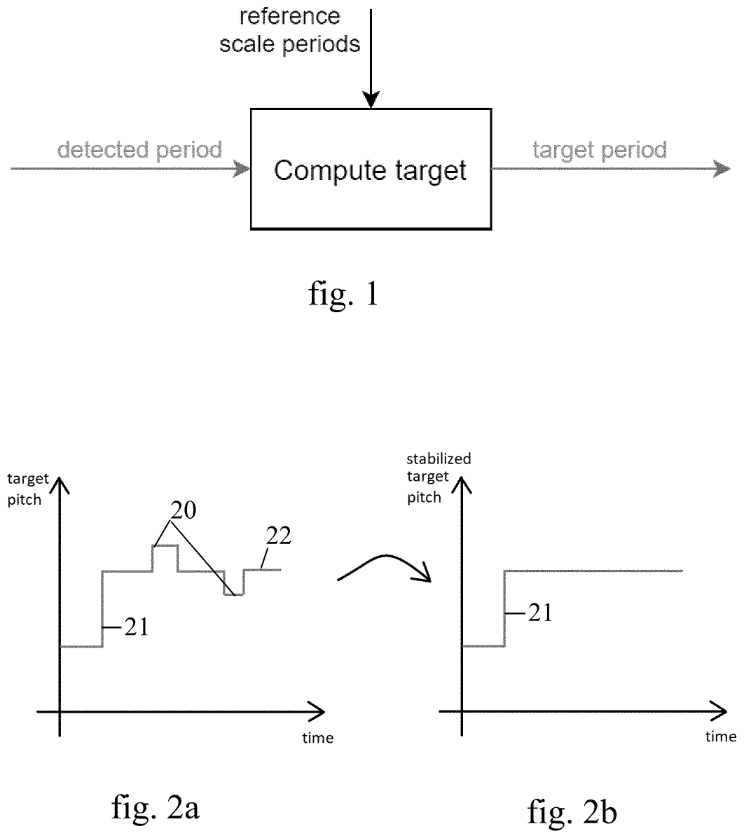

FIG. 1 is a compute target flowchart. The flowchart illustrates how a target period is computed. Before stabilization, the target period is computed based on a detected period from a pitch detection block and a plurality of reference scale periods defined by a keyboard. Each key defines several periods (1 for each octave) in samples that may be potential targets. A compute target block finds the potential target period that is the closest to the detected period on a log scale. The log scale is used because pitch and periods of each note are equally spaced on a log scale.

FIG. 2a and FIG. 2b are target pitch v. time charts before and after stabilization, respectively. The stabilizer as shown stabilizes a note structure 21 by removing brief note deviations 20 from the note structure. The goal of stabilization is to remove and replace a note deviation 20 in a conforming 22, deviating 20, conforming 22 note transition if the deviating note 20 or notes are under a certain duration (40 ms, 80 ms or 200 ms).

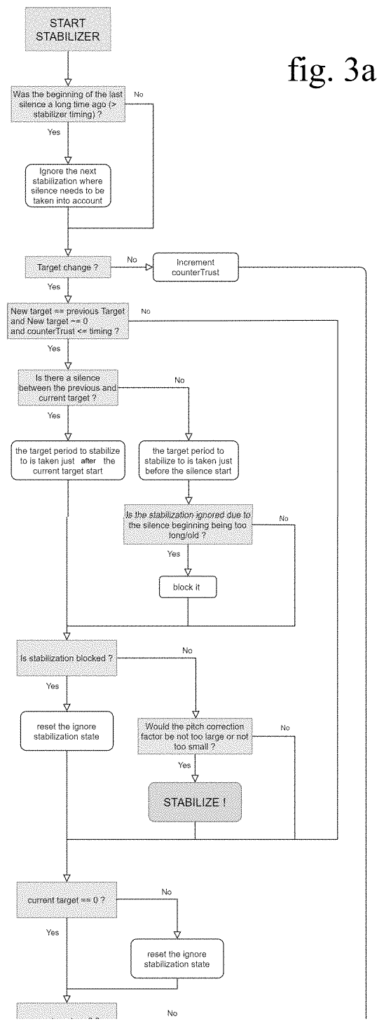

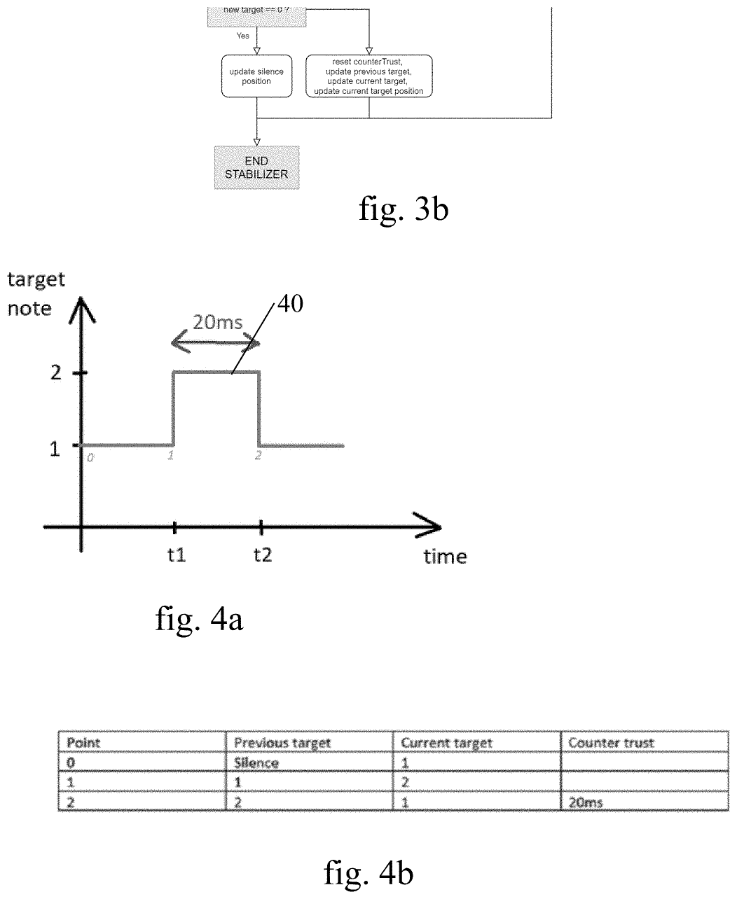

FIGS. 3a and 3b show a stabilizer algorithm flowchart. The flow chart shows that the algorithm makes stabilization decisions based on comparisons between previous and current targets and comparisons between counter trust and stabilization timing.

The stabilizer makes stabilization decisions as follows. First the stabilizer is turned on. The stabilizer's algorithm asks, how long was the beginning of the last silence. Further, is this time duration shorter or longer than the stabilizer timing setting. If the last silence duration is longer than stabilization timing, then the algorithm ignores the next stabilization order where silence needs to be considered. Thereafter, the algorithm asks if the target has changed. If the target has not changed, the algorithm activates an increment counter trust. The increment counter trust essentially measures the duration of targeted notes. If the target has changed, then the algorithm makes a plurality of comparisons. If the new target is the same as the previous target, the new target is not equal to zero, and the counter trust is less than stabilizer timing, if so then the algorithm poses another question. Otherwise the algorithm skips to a comparison between current and zero. Pursuant to the former, the algorithm makes a comparison by asking if there is a silence between the previous and current target. If there is a silence the target period to stabilize is taken after the start of the current target. If there is not a silence the target period to stabilize is taken just before the silence start. If the stabilization period is taken before silence start, the stabilization will be ignored if the silence is too old or long. Then the algorithm asks if stabilization has been blocked at any point. If stabilization has not been blocked, the algorithm asks if pitch correction factor would be not too large or not too small. If the answer is yes, the target period is stabilized. If stabilization has been blocked, then the ignore stabilization state is reset. Then the algorithm asks if the current target is zero. If it is not, then ignore stabilization state is reset. Then the algorithm assesses if the new target is zero. If it is zero, the silence position is updated, and the stabilizer cycle ends. Otherwise the counter trust is reset, and previous target, current target, and current target position are updated, and the algorithm may repeat the cycle.

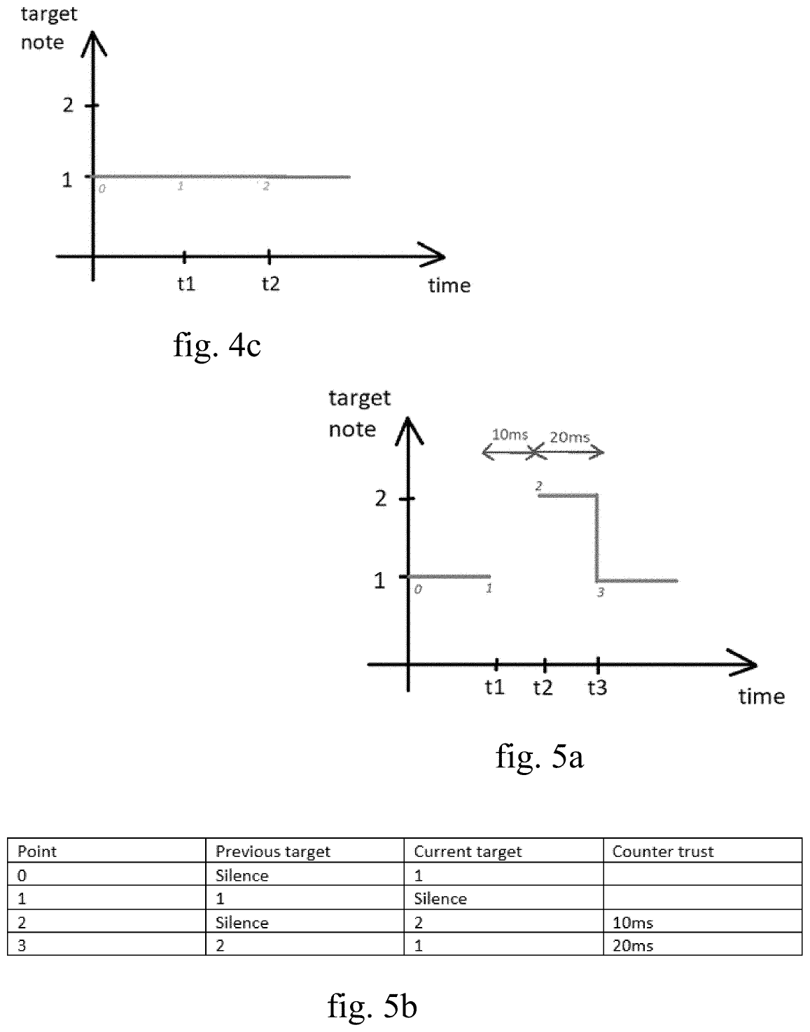

FIG. 4a and FIG. 4c show a target note v. time chart before and after stabilization. FIG. 4b shows a table relating time points and system settings. FIG. 4a shows a chart with a 20 ms note 2 transition 40. In this example, a stabilizer timing is set to 40 ms. The stabilizer timing is a reference value which note deviations are measured against. As stated, before the algorithm makes stabilization decisions based on the duration of note or target changes. The FIG. 4b chart shows these changes and the counter trusts if the algorithm is measuring it. As shown in the FIG. 4b chart, at point 0 the algorithm's pervious target is silence and current target is 1. At point 1 the algorithm has become privy to a note change and a new target is set to 2. The new target is different from the previous target which was silence so no stabilization is generated. Since the new target is not a silence a counter trust is reset to 0, previous target is set to 1, current target is set to 2, and the current target position is t₁. At point 2 the algorithm has become privy to another note change. The new target is set to 1, so the new target is the same as the previous target. The algorithm discerns that counter trust is 20 ms which is less than the stabilization timing setting of 40 ms. This results in stabilization from current target position t₁ to live position t₂ shown by the chart in FIG. 4c. Thereafter, the counter trust is reset to 0, previous target is set to 2, current target is set to 1, and current target position is t₂.

FIGS. 5a and 5c shown a target note v. time chart before and after stabilization. These charts differ from the charts shown in FIGS. 4a and 4c in that they incorporate silence. In this stabilization example stabilization timing is again set to 40 ms. FIG. 5b shows a table relating time points and system settings. Following the table shown by FIG. 5b at point 0 the previous target is silence and the current target is 1. At point 1 there is a note change and the new target is silence. Because the new target is silence, stabilization is not initiated. At point 2 there is another note change and the new target is 2. At point 3 the current target is 1. Since the current target is the same as a previous target and counter trust is less than stabilization timing the algorithm stabilizes from the current target position (t₂) to the live position (t₃). The result of the algorithmic stabilization is shown in FIG. 5c. As shown the output still has a 10 ms silence from t₁ to t₂ but the 20 ms note 2 transition from t₂ to t₃ has been stabilized to note 1.

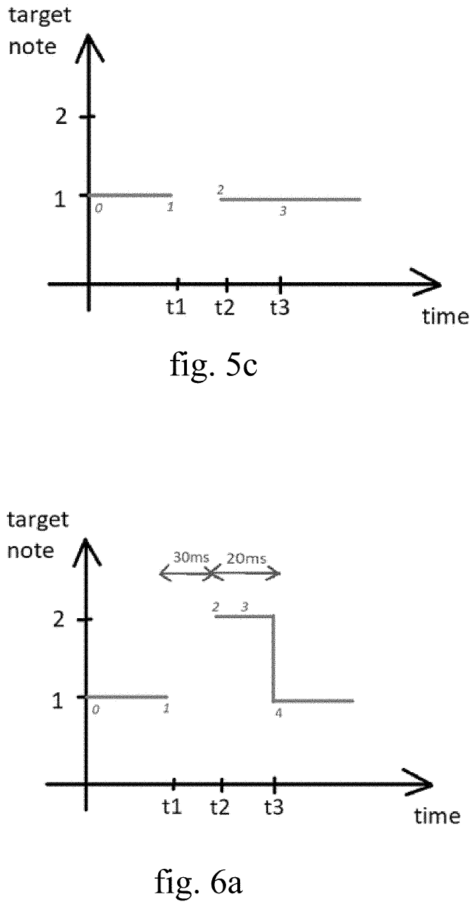

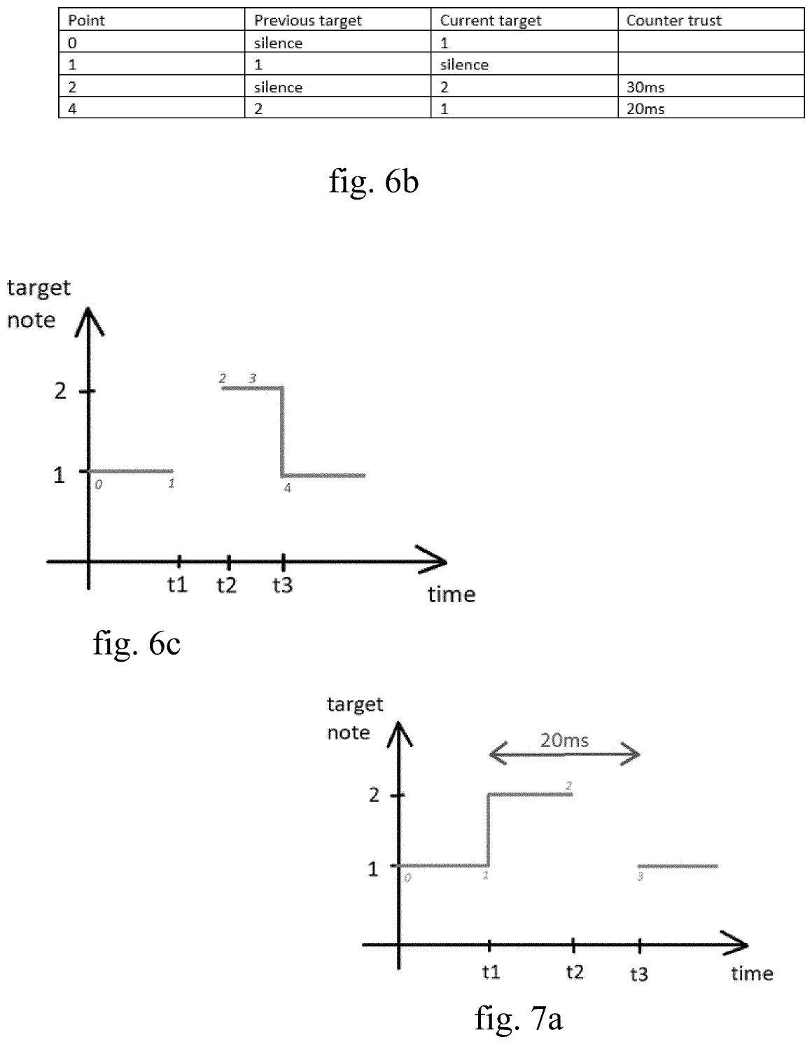

FIG. 6a and FIG. 6c show a target note v. time chart before and after stabilization. The pair of charts shown by FIGS. 6a and 6c differ from the charts shown by FIGS. 5a and 5c in that the former features a longer silence. Like prior examples, stabilization is set to 40 ms. As shown by the table in FIG. 6b, at point 0 the previous target is silence and the current target is 1. At point 1 the new target is silence. At point 2 the new target is 2. At point 3 the algorithm realizes that silence started over 40 ms ago which is greater than the stabilization timing of 40 ms so, the next stabilization attempt is ordered to be ignored. At point 4 the new target is 1 with a counter trust of 20 ms which is less than the stabilization timing of 40 ms. This should result in stabilization however the next stabilization attempt was ordered to be ignored. So, no stabilization is initiated, the result is shown by FIG. 6c which is the same as FIG. 6a.

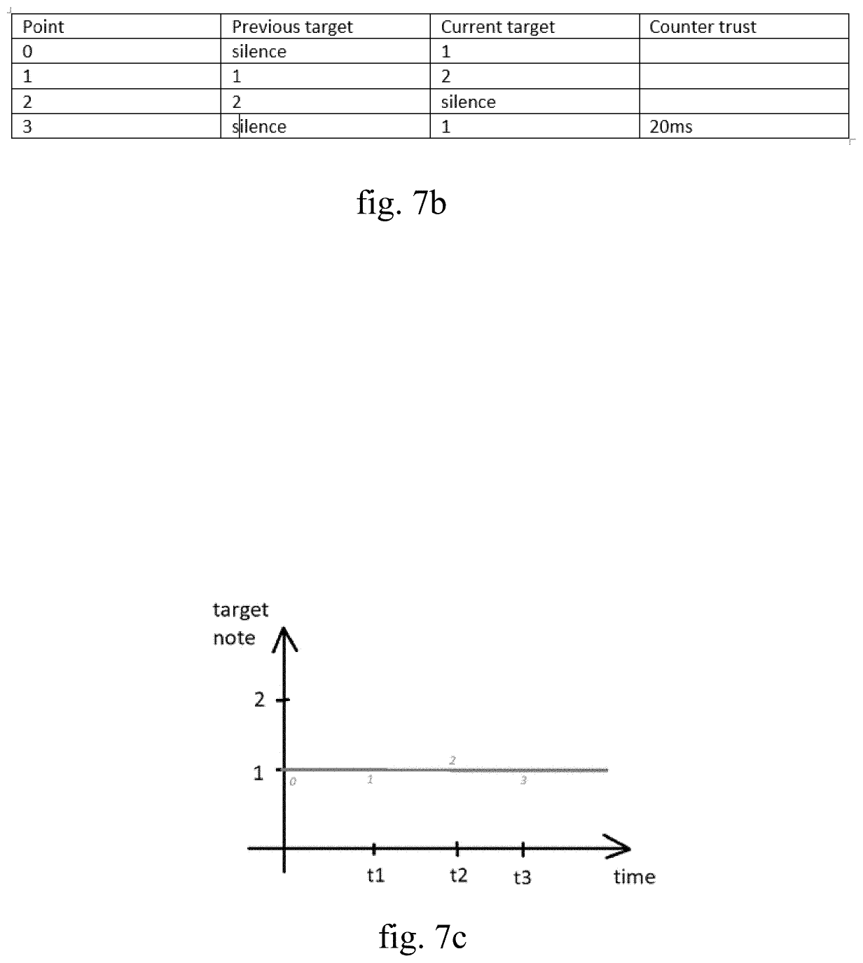

FIG. 7a and FIG. 7c show target note v. time charts before and after stabilization. FIG. 7b shows a table relating time points and system settings. Following pervious examples, stabilizer timing is 40 ms. As shown by FIG. 7b at point 0 the previous target is silence and the current target is 1. At point 1 the current target is 2 and the previous target is 1. The current target is different from the previous target, so stabilization is not initiated. The current target is not a silence, so the counter trust is reset to 0. At point 2 the current target is silence, so stabilization is not possible. At point 3 the current target is 1 and the counter trust is 20 ms which is less than the stabilization timing. This results in stabilization from t₁ to t₃. The stabilization output is shown by the target note v. time chart of FIG. 7c.

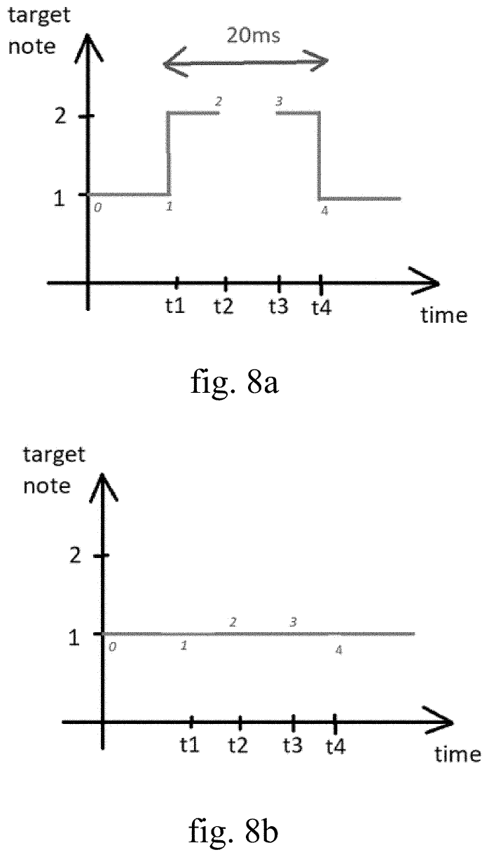

FIG. 8a and FIG. 8c show target note v. time charts before and after stabilization. FIG. 8b shows a table relating time points and system settings. Continuing previous examples, stabilizer timing is 40 ms. As shown by FIG. 8b at point 0 the previous target is silence and the current target is 1. At point 1 the previous target is 1 and the current target is 2. The current target is different from the previous target, so no stabilization is initiated. The current target is not a silence, so the counter trust is reset to 0. At point 2 the current target becomes silence, so stabilization is not initiated. At point 3 the current target becomes 2. At point 4 the current target becomes 1. The current target is the same as a previous target and the counter trust is 20 ms which is less than the 40 ms stabilization timing which yields stabilization from current target position t₁ to the live position t₄.

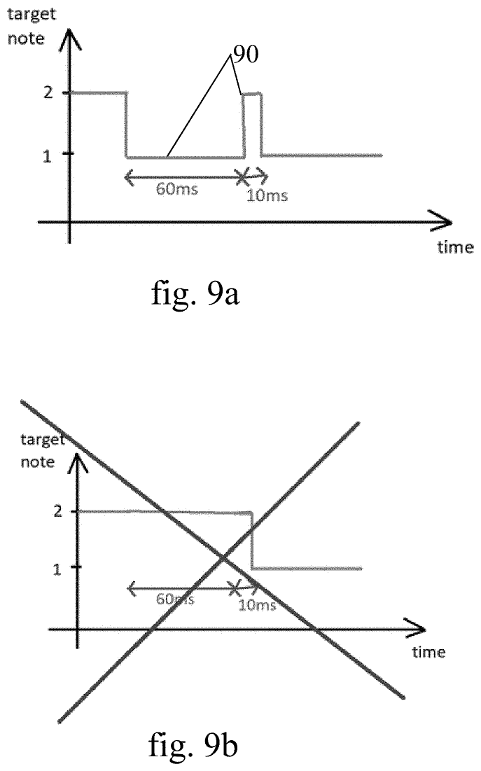

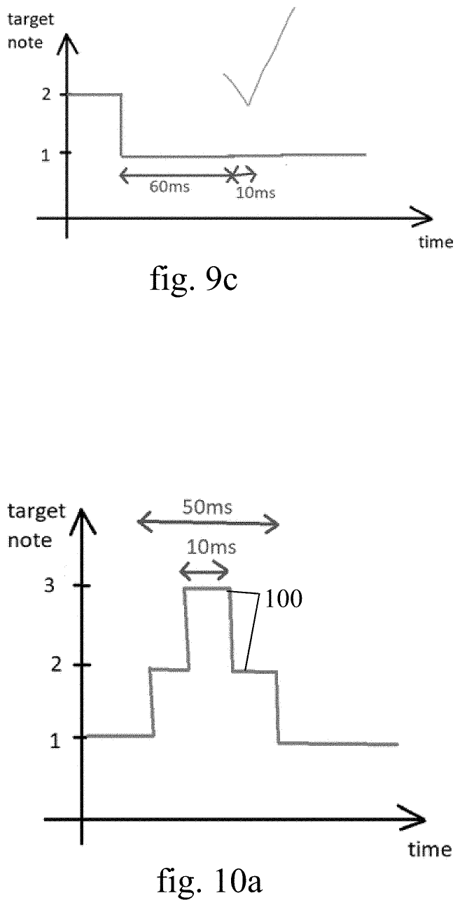

FIG. 9a, FIG. 9b and FIG. 9c show three target note v. time charts, one before and two after stabilization. The intention of these charts is to show the instances in which having more than one stabilizer is necessary for adequate stabilization. As shown in FIG. 9a there are two notes that are candidates for stabilization 90, one being a 60 ms note 1 and the other being a 10 ms note 2. FIG. 9b shows the output using only one stabilizer with an 80 ms timing. The result is that the 60 ms note is stabilized but not the 10 ms note. The chart is crossed off to illustrate that the output is ineffectively stabilized. FIG. 9c shows the output using two stabilizers one with a 40 ms timing and another with an 80 ms timing. The FIG. 9c output has been effectively stabilized by employing two stabilizers.

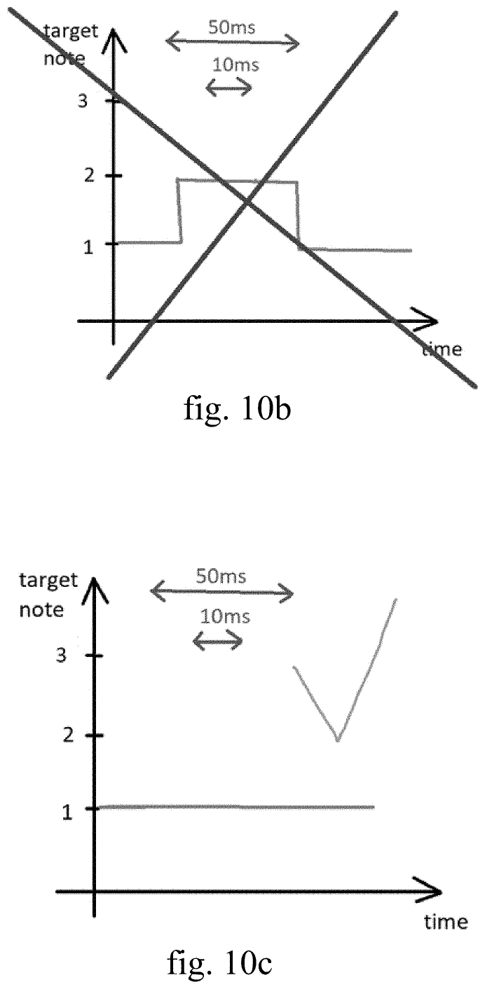

FIG. 10a, FIG. 10b and FIG. 10c show three target note v. time charts, one before and two after stabilization. The intention of these charts is to show the instances in which having more than one stabilizer is necessary for adequate stabilization. As shown in FIG. 10a there are two notes that may potentially be stabilized 100, a 50 ms note 2 and a 10 ms note 3. FIG. 10b shows the output using one stabilizer with an 80 ms timing. The result is that the 10 ms note is stabilized but not the 50 ms note. The chart is crossed off to illustrate that the output is ineffectively stabilized. FIG. 10c shows the output using two stabilizers one with a 40 ms timing and another with an 80 ms timing. As shown, the FIG. 10c output has been effectively stabilized.

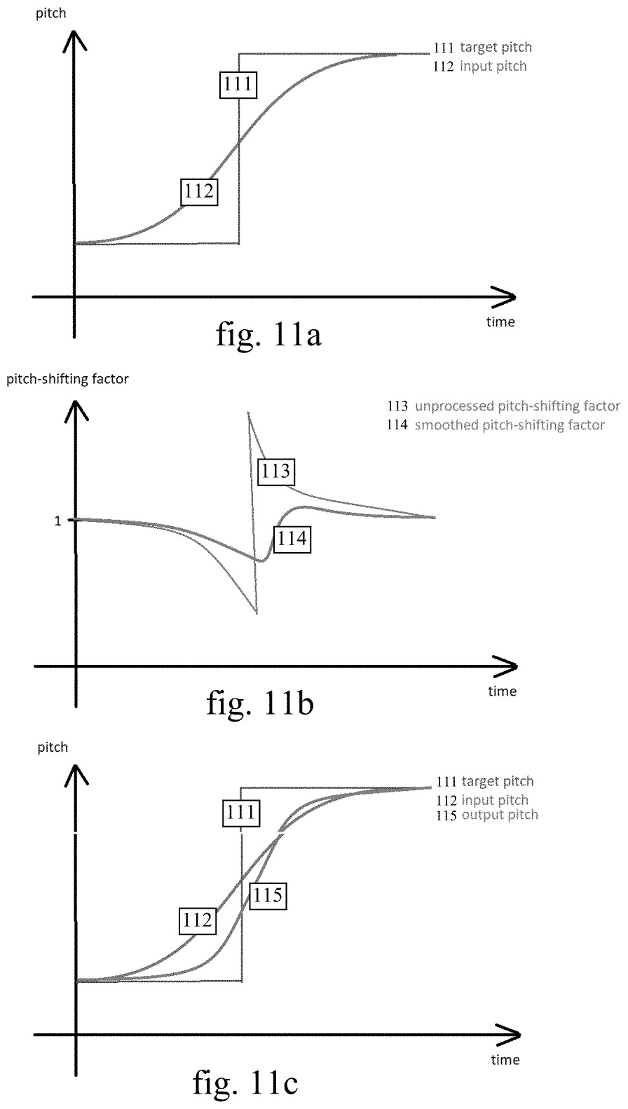

Now turning to Transition Boost instead of stabilization, FIGS. 11a and 11c show pitch v. time charts. And, FIG. 11b shows a pitch-shifting factor v. time chart. The pitch shifting factor is the amount of correction that has to be applied to the pitch in order to be perfectly in tune with the target scale. Smoothing the pitch-shifting factor is what differentiates a hard-retune effect from a natural sounding correction. Both the hard-retune and the smooth correction use the same unprocessed pitch-shifting factor but are different in how it is smoothed. A first order low pass filter is used to smooth the pitch-shifting factor. A speed value corresponding to the time constant of the filter can be used to control the amount of smoothing. The higher the speed value, the smoother the correction. FIG. 11a shows an input pitch 112 with the corresponding target pitch 111 superimposed on top of each other. 15 FIG. 11b shows unprocessed pitch-shifting factor in red and smoothed pitch-shifting factor in grey. FIG. 11c shows an input pitch 112 and the corresponding target pitch 111 superimposed on top of each other and an output pitch 115 which is the result of a smoothed pitch-shifting factor applied to the input pitch 112.

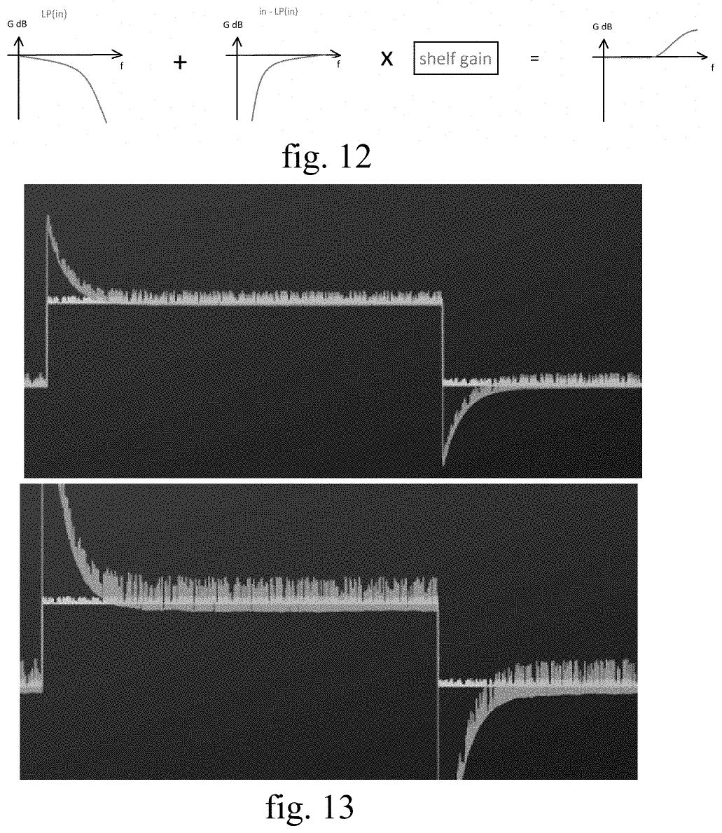

FIG. 12 is a group of charts that illustrate how negative speed is obtained. Negative speed is obtained via replacing a low-pass by a high-shelf filter to amplify note transitions rather than smoothing them. As shown in FIG. 12, combining the input and output signals of the low pass filter with a gain yields a high-shelf filter.

FIG. 13 is an outline pitch-shifting factor plot. As shown, the application of the high-shelf filter did not have the desired effect. The most desirable effect is a high shelf filter which is only active at a note transition ideally avoiding boosting high-frequency content indiscriminately as shown by the plot in FIG. 13.

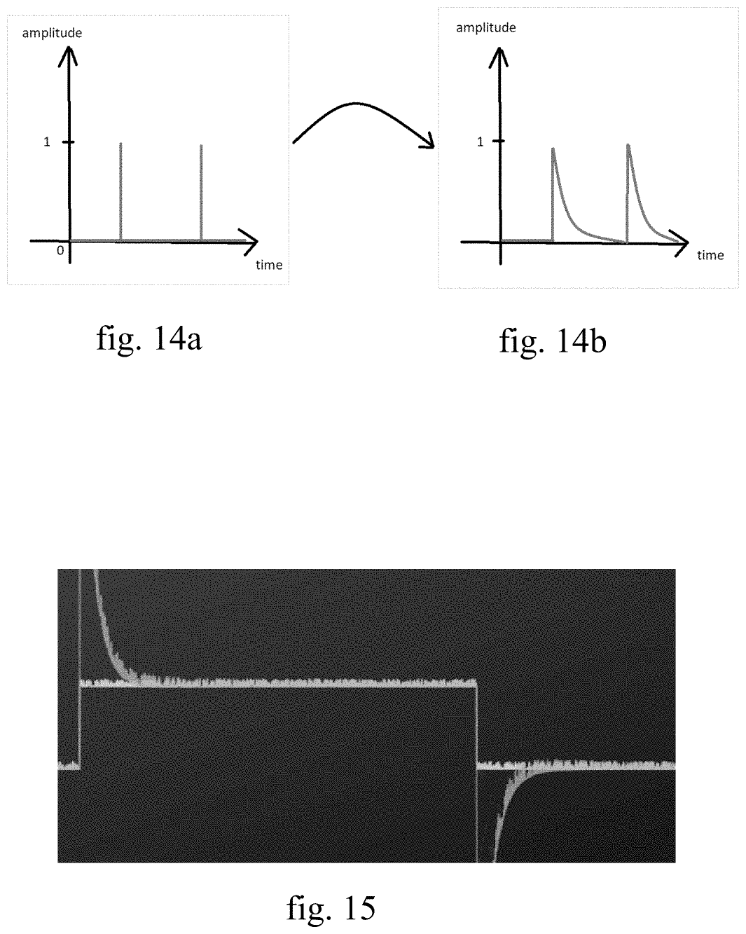

FIG. 14a and FIG. 14b show amplitude v. time charts. The chart shown by FIG. 14a is a signal which is always zero except at samples where the target note transitions occur. This signal is then processed with an envelope follower with an instantaneous attack time. The output of the envelope follower is shown by FIG. 14b.

FIG. 15 is an outline pitch-shifting factor plot. By multiplying the signal shown in FIG. 14b to the shelf gain, the high-shelf filter is ensured to only be active at note transitions.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A method to remove pitch variations due to pitch occurrences shorter than a certain duration in a retuned audio signal.

2. The method of claim 1 further comprising the steps of:
detecting the pitch of an audio signal
discretizing the values of the detected pitch
stabilizing short variations of the detected pitch signal.

3. The method of claim 2 further comprising the step of using a sequence of target pitches to discretize the values of the detected pitch.

4. The method of claim 3 wherein a sequence of target pitches {xj} is computed based on a musical scale set by the user.

5. The method of claim 3 wherein a sequence of target pitches {xj} is computed based on a sequence of musical keys set by a user.

6. The method of claim 3 further comprising the step of determining the discrete value pd of a pitch signal p depending on the sequence of target pitches {xj} as the value of {xj} at index argminj (log(p)−log(xj))

7. The method of claim 2 further comprising the step of detecting a value change in the discretized pitch signal.

8. The method of claim 7 further comprising the step of measuring the duration since the previous value change of the discrete pitch signal

9. The method of claim 8 further comprising the step of storing information on previous pitch values and their durations

10. The method of claim 9 further comprising the step of using a time threshold set by the user to control the sensitivity of stabilization

11. The method of claim 10 further comprising the step of computing a pitch correction factor threshold based on a sequence of target pitches {xj}

12. The method of claim 11 further comprising the step of analyzing said information to decide whether the current pitch p2 has to be replaced by a stabilized pitch p1.

13. The method of claim 12 further comprising the step of replacing pitch p2 by pitch pitch p1, if pitch p1 is followed by pitch p2 and pitch p1 and pitch p2 duration is inferior to the time threshold.

14. The method of claim 12 further comprising the step of replacing pitch p2 by pitch p1, when pitch p1 is followed by pitch p0 (indicating no pitch detection), pitch p2 and pitch p1, and the combined duration of pitch p2 and pitch p0 is inferior to the time threshold.

15. The method of claim 12 further comprising the step of replacing pitch p2 by pitch p1, when pitch p1 is followed by pitch p2, pitch p0 (indicating a no-detection) and pitch p1, and the combined duration of pitch p0 and pitch p2 is inferior to the time threshold.

16. The method of claim 12 further comprising the step of replacing 2 pitches p2 by pitch p1, when pitch p1 is followed by a first pitch p2, pitch p0 (indicating a no-detection), a second pitch p2 and pitch p1, and the combined duration of first pitch p2, pitch p0 and second pitch p0 is inferior to the time threshold.

17. The method of claim 12 further comprising the step of ignoring the pitch stabilization process if the ratio current pitch p1/stabilized pitch p2 or current pitch p2/stabilized pitch p1 is above the pitch correction factor threshold.

18. The method of claim 17 further comprising the step of using a two-stage stabilization process.

19. The method of claim 18 wherein the second stabilization stage uses a time threshold that is superior to the first stabilization stage.

20. The method of claim 17 further comprising the step of replacing the second pitch p2 by p1, when a first pitch p2 is followed by a first pitch p1, a second pitch p2 and a second pitch p1, when the duration of the first pitch p1 is superior to the first stabilization stage time threshold and the duration of the second pitch p2 is inferior to the first stabilization stage time threshold.

21. The method of claim 17 further comprising the step of replacing the first pitch p2, pitch p3 and second pitch p2 by pitch p1 when pitch p1 is followed by first pitch p2, pitch p3, second pitch p2 and pitch p1, when the duration of pitch p3 is inferior to the first stabilization stage time threshold and the combined duration of first pitch p2, pitch p3 and second pitch p2 is inferior to the second stabilization stage time threshold.

22. A method for enhancing or increasing the transition between two notes in a retuned audio signal.

23. The method of claim 22, comprising the steps of
detecting the pitch of an audio signal
discretizing the values of the detected pitch
enhancing pitch correction on note changes

24. The method of claim 23 further comprising the step of using a sequence of target pitches to discretize the values of the detected pitch.

25. The method of claim 24 wherein a sequence of target pitches {xj} is computed based on a musical scale set by the user.

26. The method of claim 24 wherein a sequence of target pitches {xj} is computed based on a sequence of musical keys set by a user.

27. The method of claim 24 further comprising the step of determining the discrete value pd of a pitch signal p depending on the sequence of target pitches {xj} as the value of {xj} at index argminj (log(p)−log(xj))

28. The method of claim 23 further comprising the step of detecting a value change in the discretized pitch signal.

29. The method of claim 28 wherein information of a change in the pitch target signal is used to enhance the retuning of the audio signal when the change occurs.

30. The method of claim 29 further comprising the step of computing the pitch correction signal as the discretized pitch signal divided by the detected pitch signal.

31. The method of claim 30, further comprising the step of increasing the discontinuities in the pitch correction signal when the change occurs;

32. The method of claim 31, further comprising the step of using a high-shelf filter to increase the discontinuity of the pitch correction signal;

33. The method of claim 32, further comprising the step of triggering the activation of the high-shelf filter to the pitch correction signal when there is a note change;

34. The method of claim 33, further comprising the step of activating the high-shelf filter for a limited time following the transition from the first note to the second note.

35. The method of claim 34, wherein the time during which the high-shelf filter is active can be set by the user.
